(19) United States
(12) Patent Application Publication
(10) Pub. No.: US 2026/0200165 A1
(43) Pub. Date: Jul. 16, 2026

(54) MODULAR BLOW MOLD SYSTEM FOR BLOW MOLDING A CONTAINER

(71) Applicant: PepsiCo, Inc., Purchase, NY (US)

(72) Inventors: Lukasz GORLOWSKI, Fermoy (IE); Joachim TSCHRITTER, Soltau (DE)

(21) Appl. No.: 19/016,608

(22) Filed: Jan. 10, 2025

(51) Int. Cl. B29C 49/28; B29C 49/48; B29L 31/00

(52) U.S. Cl. CPC B29C 49/28008; B29C 49/48; B29C 2049/4858; B29C 2049/4862; B29L 2031/7158

(57) ABSTRACT

A modular system for blow molding a container that include interchangeable components to allow blow molding of different sized and shaped containers using the same blow mold carrier. The system includes an interlocking coupling between the mold halves and retainer plates that allows for more efficient assembly and disassembly. The system can also accommodate molds for making containers have a width greater than 125 mm. Additionally, the system can accommodate a variety of container sizes, from a low as 100 mL up to 3 L.

### BACKGROUND

The present disclosure relates to blow systems for blow molding a container. More particularly, the embodiments relate to a modular system for blow molding a container and methods for making the same.

### BRIEF SUMMARY

Some embodiments are directed to a modular system for blow molding a container. In some embodiments, the system includes a blow mold carrier comprising a first portion, a second portion, and a base portion; a first mold removably coupled to the first portion; a flange; positioning dentils spaced apart along a height of the flange; a second mold removably coupled to the second portion; a base mold in the base portion; and a retainer plate having a longitudinal dimension parallel to the height of the flange. In some embodiments, the first portion includes a mold contacting surface extending along a height of the first portion. In some embodiments, the first mold includes positioning dentils spaced apart along a height of the flange, and the positioning dentils extend out from the flange and are configured to contact the mold contacting surface. In some embodiments, the first mold, second mold, and base mold together define a blow mold cavity when the first portion, the second portion, and the base portion are coupled. In some embodiments, the retainer plate includes protrusions extending perpendicular to the longitudinal dimension, and the protrusions are configured to extend into the space between the positioning dentils such that the protrusions contact the mold contacting surface.

In any of the various embodiments discussed herein, the system includes a spacer removably coupled to the base portion.

In any of the various embodiments discussed herein, the spacer is disposed between the base portion and a base ring, and the base ring is coupled to the first portion and to the second portion.

In any of the various embodiments discussed herein, the first mold and the second mold are interchangeable with a third mold and a fourth mold.

In any of the various embodiments discussed herein, the base mold is interchangeable with a second base mold.

In any of the various embodiments discussed herein, the blow mold cavity defined by the third mold, the fourth mold, and the second base mold has a maximum width that is different than a maximum width of the blow mold cavity defined by the first mold, the second mold, and the base mold.

In any of the various embodiments discussed herein, the third mold, the fourth mold, and the second base mold together define a blow mold cavity that has a maximum height that is different than a maximum height of the blow mold cavity defined by the first mold, the second mold, and the base mold.

In any of the various embodiments discussed herein, the blow mold cavity defined by the first mold, the second mold, and the base mold has a volume from about 100 mL to about 2 L.

In any of the various embodiments discussed herein, the first mold is interchangeable with a third mold; the second mold is interchangeable with a fourth mold; the base mold is interchangeable with a second base mold; and a blow mold cavity defined by the first mold, the second mold, and the base mold has a volume from about 2 L to about 3 L.

In any of the various embodiments discussed herein, the base mold is integral with the base portion.

In any of the various embodiments discussed herein, the first mold and the retainer plate are configured to be directly coupled to the first portion.

Some embodiments are directed to an interchangeable mold for blow molding a container. In some embodiments, the mold includes a first mold configured to engage with a first portion of a blow mold carrier. In some embodiments, the first mold includes a pair of flanges extending in opposite directions; positioning dentils extending out from the flanges, and the positioning dentils are configured to contact a mold contacting surface of the first portion of the blow mold carrier. In some embodiments, the mold includes a second mold configured to engage with a second portion of the blow mold carrier. In some embodiments, the mold includes a base mold configured to engage with the first portion and the second portion of the blow mold carrier to form a blow mold cavity defined by the first mold, the second mold, and the base mold. In some embodiments, the mold includes a retainer plate configured to couple the first mold to the first portion of the blow mold carrier.

In any of the various embodiments discussed herein, the retainer plate comprises protrusions extending perpendicular to a longitudinal dimension of the retainer plate.

In any of the various embodiments discussed herein, the retainer plate is configured to couple to the first mold such that the protrusions extend into the space between the positioning dentils.

In any of the various embodiments discussed herein, the protrusions are configured to contact the mold contacting surface.

In any of the various embodiments discussed herein, the first mold is configured to be interchangeable with a third mold, the third mold comprising a pair of flanges extending in opposite directions and positioning dentils extending out from the flanges, and the second mold is configured to be interchangeable with the fourth mold.

In any of the various embodiments discussed herein, the retainer plate is configured to couple the third mold to the blow mold carrier.

In any of the various embodiments discussed herein, the protrusions extend into the space between the positioning dentils in the third mold.

In any of the various embodiments discussed herein, the blow mold cavity defined by the first mold, the second mold, and the base mold has a volume from about 100 mL to about 2 L (e.g., from about 100 mL to about 1 L).

In any of the various embodiments discussed herein, the blow mold cavity defined by the third mold, the fourth mold, and the base mold has a volume from about 2 L to about 3 L.

### BRIEF DESCRIPTION OF THE FIGURES

FIG. 1 shows a half of a modular blow mold system coupled to a base portion.

FIG. 2 shows the assembled modular blow mold system of FIG. 1.

FIG. 3 shows an exploded view of the half of the modular system and base portion of FIG. 1.

FIG. 4A shows a cross-sectional view of the half of the modular system of FIG. 1 with a mold.

FIG. 4B shows the cross-section view of FIG. 4A but with a different mold having a different sized mold.

FIG. 5 shows a cross-sectional view of the half of the modular system of FIG. 1 taken along line 5-5 of FIG. 1.

FIG. 6 shows a flow chart illustrating methods of assembling the modular blow mold system of FIGS. 1-5.

### DETAILED DESCRIPTION

Some blow mold systems (e.g., shell mold, hot-fill mold, full-body mold, and small-cavity mold) use components generated using CAD (computer-aided design)/CAM (computer-aided manufacturing) systems. These systems may use laser engraving or etching for complex design features. These systems can be expensive and require a significant amount of time to manufacture after design. These systems may be used to make beverage containers using a blow mold process that involves placing a preform in a mold. The preform is heated, and then air is blown into the preform to blow the heated preform material to form a container matching the shape of the mold.

But developing a new container design can be an iterative process. This design process may involve creating multiple new molds as the design is conceived, developed, and refined. Accommodating this iterative process can be a long and expensive process for existing blow mold systems. And the time required to produce the next iteration can delay the production cycle such that multiple iterations may not be economically feasible. Accordingly, with existing blow mold systems, costs and time may prevent more than one or two molds from being produced before a full-scale production model is produced.

Additionally existing mold systems often have dimensional restrictions that prevent using the same mold system to develop various sized containers. For example, many existing systems can accommodate molds for containers having only a certain volume (e.g., 1 L or less) and cannot accommodate larger format containers (e.g., up to 3 L). Larger format containers often require an entirely different mold system specifically designed for larger format containers.

Moreover, in existing systems, a shell was required in addition to the mold components, and then the combined shell/mold was inserted into the blow mold system. This configuration restricts the available width for the container mold, meaning that wider and larger format molds could not be used. For example, existing systems that can accommodate smaller format bottles (e.g., 1 L or less) are typically not able to accommodate molds with container cavities having widths larger than 110 mm. The use of the shell also makes assembly and manufacture more complicated.

Embodiments described here overcome these and other challenges by providing—among other benefits—a modular blow mold system that can use one carrier device to accommodate various container sizes (e.g., 100 mL up to 3 L), and the molds can be coupled directly to the carrier device (e.g., without intervening shells). Additionally, embodiments described herein include improved mechanisms for coupling molds to the carrier device.

Using the blow mold systems according to embodiments disclosed herein, it is possible to produce a modular blow mold system that accommodates container molds for blow molding a wide variety of container sizes, for example varying widths, heights, and volumes. Embodiments disclosed herein simplify the iterative design process by eliminating the shell between the container mold and the blow mold system. Instead, container molds couple directly to a blow mold system, rather than to a shell, which is then attached to the blow mold system. This can reduce tooling costs and minimizes lead time on each container design and each iteration of the design process. Further, the blow mold systems disclosed herein can be used in pilot scale and production scale processes. Further, embodiments disclosed herein include interchangeable molds so that portions of the blow mold system can be reused each time a new bottle design is used. These mold systems have improved strength, flexibility, and surface quality while also enabling repetitive prototyping for new bottle design.

Finally, embodiments disclosed herein can use the same system to accommodate molds for making containers of nearly any container size commonly sold (e.g., from as small as 100 mL to as large as 3 L). As detailed below and in the figures, embodiments disclosed herein the same system can accommodate molds for making bottles with varying widths and/or varying heights.

The modularity of the disclosed systems also allows the systems (e.g., modular blow mold system 100) to accommodate a variety of bottle sizes and concepts to provide rapid switching of designs before a final design is locked in. Additionally, the mold systems disclosed herein are capable of producing bottles with a surface quality sufficient for pilot scale or even full production scale, which can have the capability to produce millions of bottles. And the same system (e.g., modular blow mold system 100) can be used across different platforms, from lab-scale all the way to full production scale (e.g. on a linear blow molder).

All of these benefits can result in accelerated production times and blow mold systems that are much more flexible. For example, after a new container has been designed, a new mold may be ready for use within about 2 days, compared to 4 to 5 weeks for existing systems. And costs to produce each mold may be reduced by as much as 80% to 90%.

As shown throughout the figures, modular blow mold system 100 may include a carrier device that includes a first portion 105, a second portion 110, and a base 115. In some embodiments, first portion 105 and second portion 110 are mirror images of one another (possibly with differences within the mold cavity depending on the bottle design). Some embodiments disclosed herein are discussed with reference to first portion 105, but it is to be understood that all discussion of first portion 105 applies to second portion 110. For example, all components present in first portion 105 may have a corresponding component on second portion 110, and second portion 110 may have the same functionality as first portion 105.

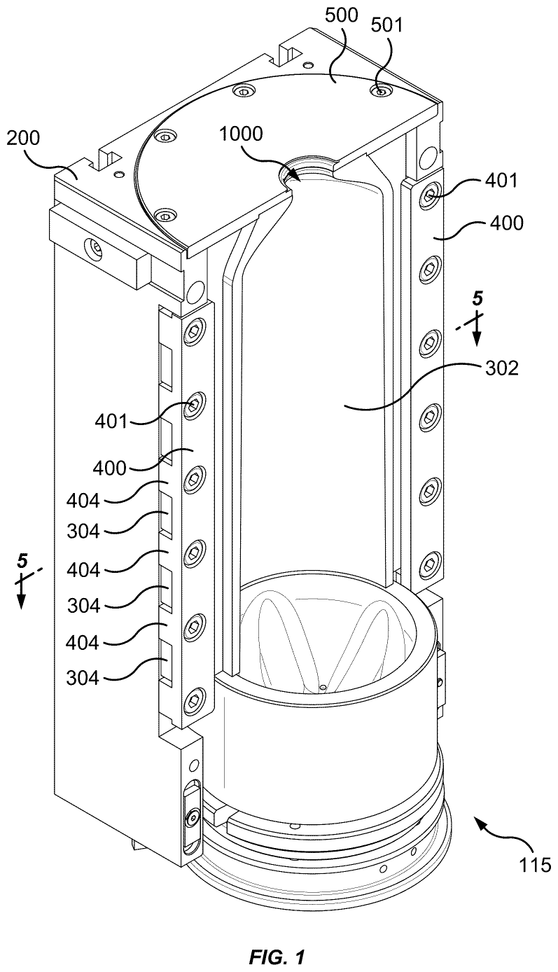

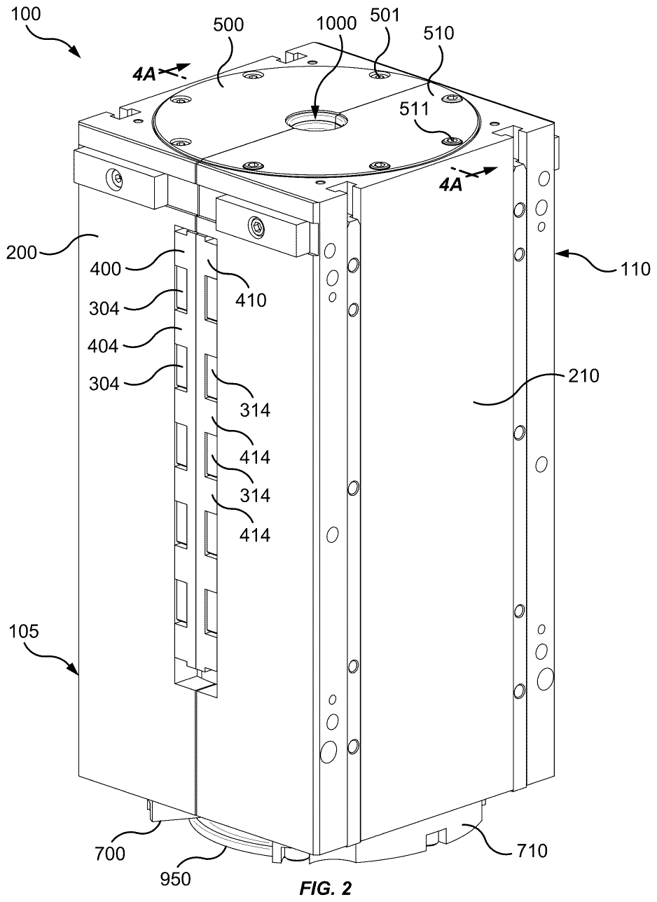

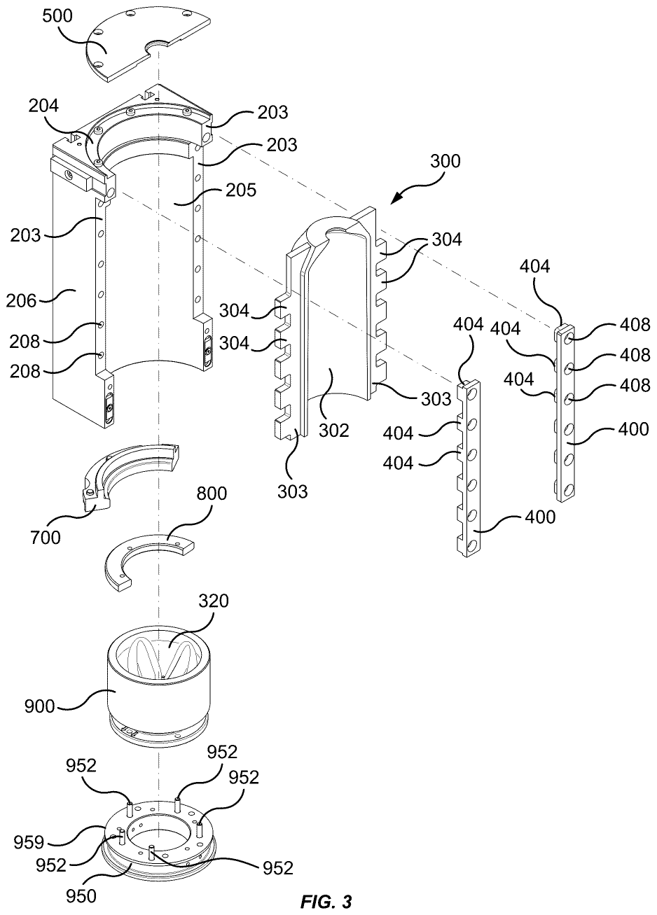

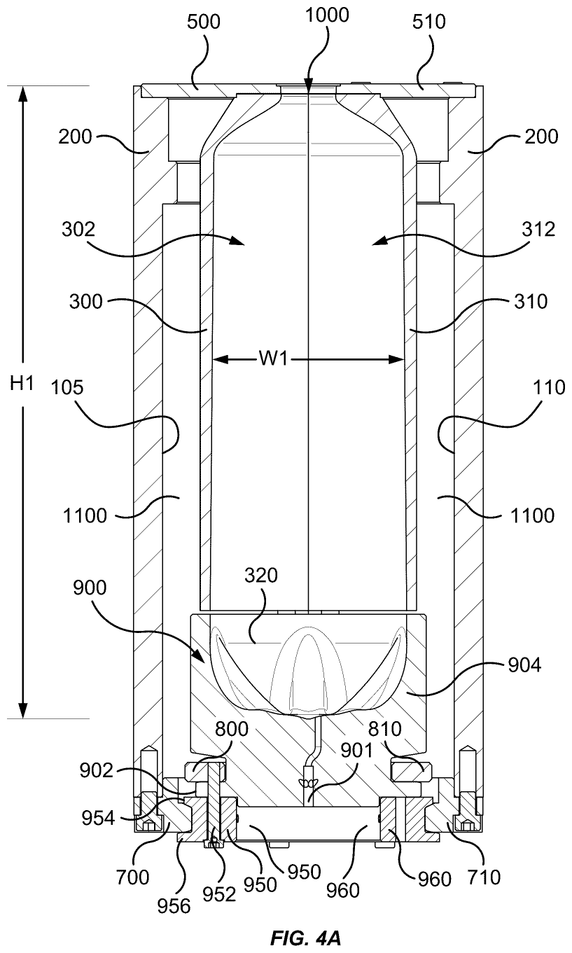

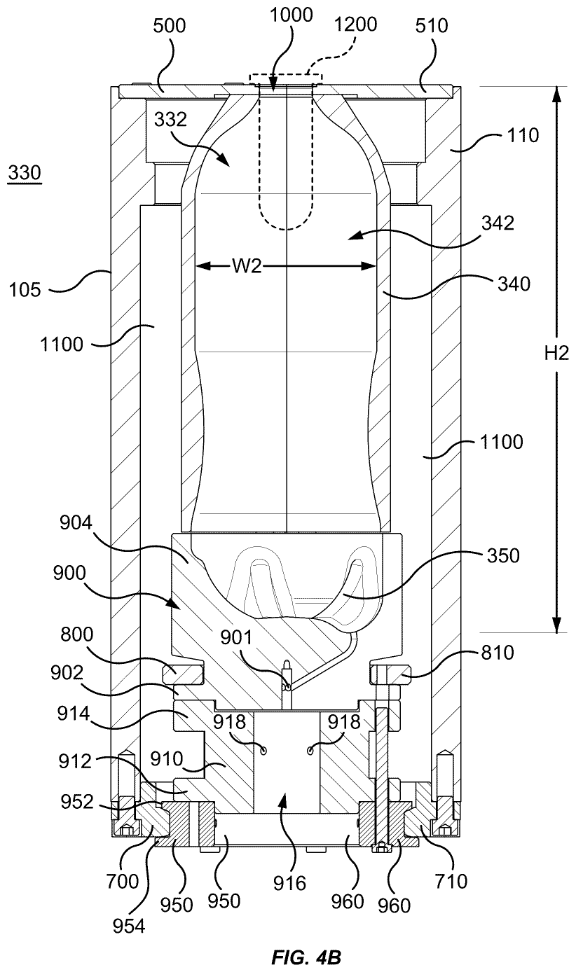

FIG. 1 illustrates first portion 105 of modular blow mold system 100 coupled to base 115. first portion 105 may include mold receiving portion 200, mold portion 300, retainer plates 400, top plate 500, cavity retainer 700, and locking ring 800 (see, e.g., FIG. 3). Second portion 110 may include corresponding parts, including mold receiving portion 210, mold portion 310, retainer plates 410, top plate 510, cavity retainer 710, and locking ring 810 (see, e.g., FIGS. 2, 4A, 4B). Base 115 may include base portion 900, spacer 910, and base mold portion 320.

FIG. 2 illustrates modular blow mold system 100 when first portion 105, second portion 110, and base 115 are assembled. When assembled, as shown in FIG. 2, mold portions (e.g., mold portion 300, mold portion 310, and base mold portion 320) form an opening 1000 and a blow mold cavity inside of modular blow mold system 100. Opening 1000 may be sized to receive a preform (e.g., preform 1200, see FIG. 4). The blow mold cavity may correspond to the shape of the containers to be blow molded. The blow mold cavity may have a height (e.g., H₁, H₂) and a width (e.g., W₁, W₂). As detailed below, mold portions 300 and 320 can be interchangeable with other mold portions (e.g., mold portions 330 and 340) that can form a blow mold cavity having a different height and/or a different width.

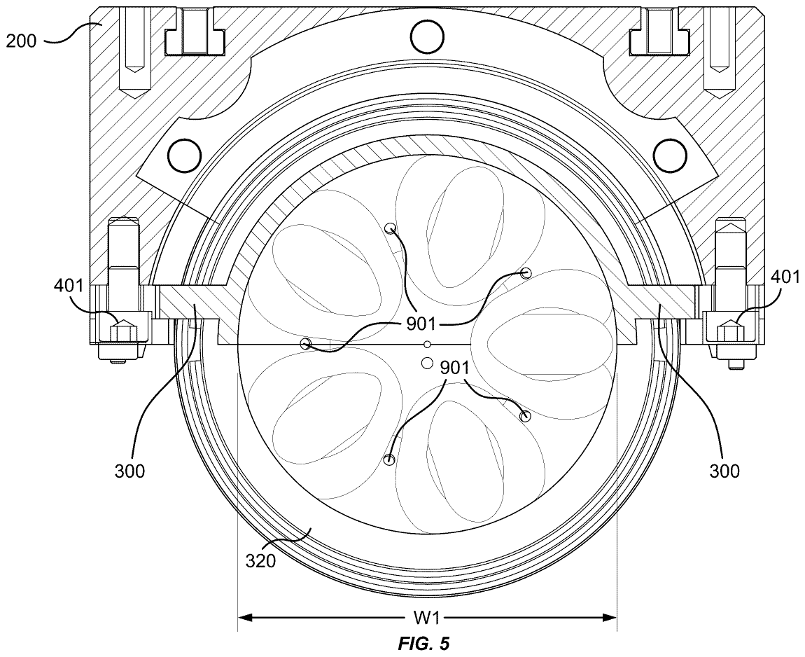

FIG. 3 shows an exploded view of first portion 105 of modular blow mold system 100. Each of these components are discussed in detail below. FIG. 4A illustrates a cross-section 4A-4A of system 100 shown in FIG. 2 with mold portions 300 and 310. FIG. 4B illustrates cross-section 4A-4A of system 100 shown in FIG. 2 with mold portions 320 and 330. As shown by FIGS. 4A and 4B, system 100 can be used to make a container having different sizes. FIG. 5 illustrates a cross-sectional view of first portion 105, base mold portion 320, and base portion 900, of modular blow mold system 100 taken along line 5-5.

A benefit of the disclosed system is the versatility of the system. Modular blow mold systems disclosed herein (e.g., modular blow mold system 100) may be able to accommodate any variety of container shape or size but also be compatible with existing blow mold systems. For example, modular blow mold system 100, may be the size of a traditional blow mold system such that system 100 can be used in existing manufacturing processes for blow molding containers. Additionally, modular blow mold system 100 may be used at lab scale, pilot scale, or full production scale (e.g., using a linear blow molder).

The modular systems (e.g., modular blow mold system 100) disclosed herein also improve flexibility. For example, certain components may be reused regardless of the height, width, or volume of the container to be molded. For example, first portion 105 and second portion 110, retainer plates 400 and 410, top plates 500 and 510, cavity retainers 700 and 710, locking rings 800 and 810, base portion 900 may be reusable components. These reusable components may be made of metal. In some embodiments, the reusable components are computer numerical control (“CNC”) machined metal.

Other components, such as the mold portions (e.g., mold portions 300, 310, 320, 330, and 340) may be interchangeable. Additionally, spacer 910 may be reusable but also interchangeable depending on the height of the container to be molded. For example, for molds that make shorter containers, a taller spacer 910 may be used. For molds that make taller containers, a shorter spacer 910 may be used, or no spacer 910 may be used.

The interchangeable components may be compatible with the reusable components. For example, the mold portions (e.g., mold portions 300 and 310) and base mold portion 320 together may form a mold corresponding to a bottle shape. Any bottle shape may be made by simply replacing the mold portions (e.g., mold portions 300 and 310 and base mold portion 320) with different molds (e.g., mold portion 330 and 340) that are compatible with the reusable components. In some embodiments, the interchangeable components are 3D printed using a polymer, as described in U.S. Pat. No. 11,179,875, which is incorporated by reference hereto.

Another benefit to embodiments disclosed herein is that the mold portions can be couple directly to first and second portion 100 and 105 of the carrier, without a shell between the mold portions and the blow mold halves. First portion 105 may have a mold contacting surface 203, a top plate contacting surface 204, an inner surface 205, and an outer surface 206.

As described below and shown in FIGS. 1-3, mold portion 300 and retainer plates 400 form an interlocking structure that couples mold portion 300 to first portion 105. This structure allows for mold portion 300 to be coupled directly to first portion 105 (e.g., without an intermediate shell) without requiring any holes (e.g., to receive fasteners) in mold portion 300. Instead, retainers 400 may be fastened (e.g., by fasteners 401) to first portion 105. The interlocking structure of mold portion 300 with retainer plate 400 ensures that mold portion 300 is secured without requiring screws through mold portion 300.

Mold portion 300 may include container mold 302 and flanges 303. Flanges 303 may contact with mold contacting surface 203 on first portion 105. In some embodiments, as shown in FIG. 3, mold portion 300 may have two flanges 303 on opposing sides of mold portion 300. In some embodiments, each flange may include a series of positioning dentils 304. In some embodiments, positioning dentils 304 extend out from mold portion 300. Positioning dentils 304 may contact mold contacting surface 203. When mold portion 300 is contacting mold contacting surface 203, there are spaces between positioning dentils 304, leaving portions of mold contacting surface 203 exposed.

Each portion 105 and 110 can include two retainer plates (e.g., retainer plates 400 and 410). Each retainer plate 400 can include a series of protrusions 404. In some embodiments, protrusions 404 are configured to be inserted in the space between positioning dentils 304. In some embodiments, one or more protrusions 404 includes an opening 408 that aligns with an opening 208 in first portion 105. Fastener 401 (e.g., screws) can be inserted through both opening 208 and opening 408 to couple retainer plate 400. In some embodiments, as shown in FIGS. 1 and 3, each retainer plate 400 can include a series of openings 408 that align with a series of openings 208 in first portion 105. Retainer plates 400 may be interchangeable, depending on the size of the mold portion 300 used.

When assembled, protrusions 404 can extend between positioning dentils 304 and contact mold contacting surface 203 of first portion 105. In some embodiments, protrusions 404 are in direct contact with mold contacting surface 203. Positioning dentils 304 can also contact mold contacting surface 203. In some embodiments, positioning dentils 304 are in direct contact with mold contacting surface 203. In some embodiments, both positioning dentils 304 and protrusions 404 are in direct contact with mold contacting surface 203. Mold portion 300 can be secured to first portion 105 using only retainer plates 400 (i.e., by the interlocking structure formed by positioning dentils 304 and protrusions 404 of retainer plates 400). For example, in some embodiments, no fasteners (e.g., fasteners 401) are used to attach mold portion 300 and instead only retainer plates 400 hold mold portion 300 in place.

When mold portion 300 is coupled to mold receiving portion 200 of first portion 105, a space is formed between inner surface 205 and container mold 302. Container mold 302 may be a container-specific shape, and may be redesigned as needed to accommodate different container designs and sizes. The shape and size of the portions of flanges 303 that contact mold contacting surface 203 may remain the same even as container mold 302 is adjusted in size and shape. This allows mold portion 300 to easily engage with first portion 105. In some embodiments, retainer plates 400 and top plate 500 are used to secure mold portion 300 to first portion 105. For example, as discussed above, retainer plates 400 can couple to first portion 105 at mold contacting surface 203, which holds mold portion 300 in place.

Top plate 500 may be shaped to seat at top plate contacting surface 204 of first portion 105. Top plate 500 may be coupled to first portion 105 using screws. First portion 105, mold portion 300, and top plate 500 together form volume 1100 (see, e.g., FIGS. 4A and 4B). In some embodiments, no filler is required and volume 1100 may remain empty during use. In some embodiments, a filler material may be used to further increase the strength of modular blow mold system 100. For example, a filler material may be backfilled into volume 1100 after assembly of mold portion 300. During the blow molding process, the molds are subjected to pressure from within the blow mold cavity. In some embodiments, the filler material may further improve the strength of the molds because the filler material is relatively incompressible and helps the mold support the internal pressures without deflecting.

Cavity retainer 700 may be positioned secure base ring 950. When coupled, cavity retainer 700 may also enclose volume 1100. For example, base ring 950 can include an upper flange 954 and a lower flange 956. As shown in FIGS. 1, 4A, 4B, and cavity retainer 700 can be inserted between upper flange 954 and lower flange 956, and cavity retainer 700 can be coupled to a bottom surface of first portion 105.

As shown in FIGS. 4A and 4B, base portion 900 can include a flange (e.g., flange 902) that defines a recess. This flange 902 structure means base 900 can accommodate varying widths without requiring a wider mold system. For example, upper portion 904 of base 900 can have a larger or smaller diameter (e.g., to accommodate wider or thinner containers) without changing the width of base portion 900 at flange 902 or the recess defined by flange 902. Locking ring 800 can be inserted to the recess and couple to flange 902. In some embodiments, locking ring 800 is a clamp ring. In some embodiments, as detailed below, system 100 can include a spacer between base ring 950 and base portion 900 to adjust the height of the blow mold cavity. Fasteners 952 can be used to couple base portion 900, locking ring 800, spacer 910 (in embodiments that use spacer 910), and base ring 950. In some embodiments, fasteners 952 extend through cavity retainer 700, base ring 950, flange 902 of base portion 900, and locking ring 800. Spacer 910 can have a lower flange 912 and an upper flange 914, as shown in FIG. 4B. In some embodiments, cavity retainer 700 is coupled to mold receiving portions 200 and 210.

In embodiments that use spacer 910, as shown in FIG. 4B, fasteners 952 also extend through spacer 910 (e.g., through lower flange 912 and upper flange 914). In some embodiments, spacer 910 has a hollow core 916. This can allow air to more easily flow, for example, to venting channels 901. In some embodiments, venting channels 901 enable release of pressure from the mold during blow molding. Additionally, spacer 910 may have one or more channels 918 that extend through side walls of spacer 910. In some embodiments, channels 918 are venting channels that release pressure from the mold during blow molding. This can improve air flow and cooling capabilities. In some embodiments, spacer 910 includes 4 cooling channels.

Base 115 of modular blow mold system 100 may include base portion 900 and base mold portion 320. Base mold portion 320 may be a mold corresponding to the base of a container. In some embodiments, base portion 900 may be interchangeable with another base portion that has a base mold portion that is a different shape than base mold portion 320. In some embodiments, the base mold portion 320 is integral with the rest of base portion 900. In some embodiments, the base mold portion 320 is removably coupled to the rest of base portion 900. Base 115 may be coupled to first portion 105 and second portion 110 to form modular blow mold system 100. When first portion 105, second portion 110, and base 115 are coupled, the mold portions (e.g., mold portions 300 and base mold portion 320) form a blow mold cavity that corresponds to the shape of a container. In some embodiments, the blow mold cavity has a volume from about 100 mL to about 3 L, from about 500 mL to about 2 L, from about 1 L to about 1.5 L, or within a range having any two of these values as endpoints.

To blow mold containers with different sizes as discussed above, mold portions 300, 310, and base mold portion 320 may be interchangeable with other molds (e.g., mold portions 330, 340, and base mold portion 350). Additionally, spacer 910 may be interchangeable with a different size spacer. In this way, the same system can be readily adapted to blow mold various sized containers.

In some embodiments, mold portions 300 and 310 are replaceable with mold portion portions 330 and 340. Mold portions 300, 310, 330, and 340 may each include a container mold (e.g., container molds 302, 312, 332, and 342). Similarly, base mold portion 320 may be replaceable with base mold portion 350. In some embodiments, container molds 302 and 312 and base mold portion 320 may together form a container mold cavity having a height H₁ and a width W₁. In some embodiments, container molds 322 and 332 and base mold portion 350 may together form a container mold cavity having a height H₂ and a width W₂. In some embodiments, height H₁ is a different height than height H₂ and width W₁ is a different width than W₂. In some embodiments, the mold cavity has a maximum height from about 125 mm to about 350 mm, from about 150 mm to about 325 mm, from about 175 mm to about 275 mm, from about 200 mm to about 250 mm, or within a range having any two of these values as endpoints. In some embodiments, the mold cavity has a maximum width from about 50 mm to about 150 mm, from about 75 mm to about 125 mm, from about 90 mm to about 110 mm. In some embodiments, the mold cavity has a maximum width of at least 125 mm. In some embodiments, the mold cavity has a maximum width from about 125 mm to about 150 mm.

In some embodiments, system 100 includes a spacer (e.g., spacer 910) to adjust the height of the container mold cavity. In some embodiments, no spacer 910 is used, as shown in FIG. 4A. Spacer 910 can be interchangeable with another spacer having a height different than a height of spacer 910. In some embodiments, spacer 910 has a height from about 10 mm to about 250 mm, from about 12 mm to about 232 mm, from about 25 mm to about 150 mm, from about 50 mm to about 100 mm, or within a range having any two of these values as endpoints. In some embodiments, spacer 910 has a height from about 30 mm to about 115 mm. In some embodiments, spacer 910 has a height of about 30 mm. In some embodiments, spacer 910 has a height of about 50 mm. In some embodiments, spacer 910 has a height of about 70 mm. In some embodiments, spacer 910 has a height of about 90 mm. In some embodiments, spacer 910 has a height of about 110 mm. In some embodiments, system 100 includes a first spacer 910 and a second spacer 910. In some embodiments, system 100 includes 1 or more (e.g., 2 or more, 3 or more, 4 or more or 5 or more) spacers 910. In some embodiments, first spacer 910 has a height of about 30 mm, about 50 mm, about 70 mm, about 90 mm, or about 110 mm. In some embodiments, second spacer 910 has a height of about 30 mm, about 50 mm, about 70 mm, about 90 mm, or about 110 mm. In some embodiments, the height of second spacer 910 is different than the height of first spacer 910. In addition to spacer 910, base portions with different heights can be used to allow for precise variations in height. For example, in some embodiments, interchangeable spacers 910 may have incremental height differences (e.g., 10 mm, 25 mm, etc.). By accommodating base portions 900 with different heights, it is possible to create a container mold cavity having any height between incremental heights of spacers 910.

In some embodiments, second portion 110 has the same parts as first portion 105. In some embodiments, all of the component parts of second portion 110 are mirror images of the corresponding part of first portion 105. For example, second portion 110 may include top plate 510, mold portion 310, retainer plates 410, cavity retainer 710, and locking ring 810 that are mirror images of first portion 105, top plate 500, mold portion 300, retainer plates 400, cavity retainer 700, and locking ring 800, respectively. In some embodiments, second portion 110 is a mirror image of first portions 105 except for differences within the mold cavity depending on the bottle design. Second portion 110 may couple to first portion 105 and base 115.

Blow mold system 100 may include opening 1000. In some embodiments, opening 1000 is configured to receive a preform for a container (e.g., preform 1200), as illustrated in FIG. 4B. The preform may be a standard preform for making a blow mold container. The preform may be made of any variety of blow moldable plastic (e.g., PET).

Mold portions (e.g., mold portion 300 and base mold portion 320) and cavity retainers (e.g., cavity retainer 700) may be made of any suitable material, including CNC machined metal, 3D printed material, or combinations thereof.

Venting channels may be included in the base portion to improve pressure regulation during blow molding. For example, as shown in FIG. 5, venting channels 901 may be included in base mold portion 320. In use, venting channels 901 help relieve pressure build up in the mold during blow molding.

Modular blow mold systems disclosed herein (e.g., modular blow mold system 100) may be durable enough to be used at pilot scale and have a life cycle of at least 5000 containers (e.g., at least 7500 containers, at least 10,000 containers, at least 15,000 containers). In some embodiment modular blow mold system 100 is durable enough to be used at production scale (e.g., using a linear blow molder) and have a life cycle of at least 100,000 containers (e.g., at least 250,000 containers, at least 500,000 containers, at least 1,000,000 containers, or at least 2,000,000 containers).

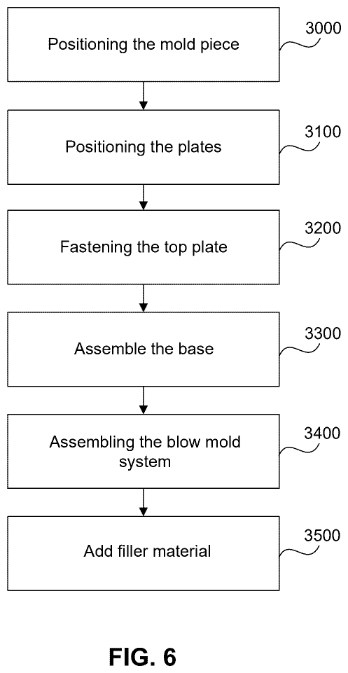

Modular blow mold system 100 may be readily assembled and disassembled. Additionally, modular blow mold system 100 may be readily reconfigured for blow molding containers having varying widths, heights, and base configurations. The steps of assembling blow mold system 100 are illustrated by the flow chart in FIG. 6. First portion 105 may be assembled at step 3000 through 3400. At step 3000, mold portion 300 is positioned so that positioning dentils 304 of mold portion 300 align with mold contacting surfaces 203 of first portion 105. Then at step 3100, retainer plates 400 are positioned over flanges 303 of mold portion 300 such that protrusions 404 are inserted between positioning dentils 304 and contact mold contacting surface 203. Fasteners 401 may be used to couple the retainer plates 400 to first portion 105. At step 3200, top plate 500 is then fastened to first portion 105 using fasteners 501 at top plate contacting surface 204. At step 3300, the base is assembled. Base ring 950 can be coupled to base portion 900 and locking ring 800. In some embodiments, a spacer 910 is used between base ring 950 and base portion 900, as shown in FIG. 4B. The base may be assembled by attaching fasteners that extend through base ring 950, flanges 902 of base portion 900, locking ring 800, and spacer 910 (in embodiments including spacer 910). At step 3400, the assembled base is coupled first portion 105 by cavity retainer 700 and to second portion 110 by cavity retainer 710. Once first portion 105 and second portion 110 are coupled, the modular blow mold system 100 forms a blow mold cavity defined by each of the mold portions (e.g., mold portions 300 and 310 and base mold portion 320). Optionally, at step 3500, volume 1100 may be filled with a filler material. In some embodiments, filler material fills the entire volume 1100. In some embodiments, filler material fills less than the entire volume 1100, for example only the space behind mold portions 300 and 310.

As used herein, the terms “top,” “inner,” “outer,” and the like are intended to assist in understanding of embodiments of the disclosure with reference to the accompanying drawings with respect to the orientation of the beverage closure as shown, and are not intended to be limiting to the scope of the disclosure or to limit the disclosure scope to the embodiments depicted in the Figures. The directional terms are used for convenience of description and it is understood that a closure and a container may be positioned in any of various orientations.

As used herein, when the term “about” is used in describing a value or an end-point of a range, the disclosure should be understood to include the specific value or end-point referred to. As used herein, the term “about” may include ±10%.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The breadth and scope of the present disclosure should not be limited by any of the above-described exemplary embodiments, but should be defined only in accordance with the following claims and their equivalents.

What is claimed is:

1. A modular system for blow molding a container, the system comprising:
a blow mold carrier comprising a first portion, a second portion, and a base portion, wherein the first portion comprises a mold contacting surface extending along a height of the first portion;
a first mold removably coupled to the first portion, wherein the first mold comprises:
a flange; and
positioning dentils spaced apart along a height of the flange, wherein the positioning dentils extend out from the flange and are configured to contact the mold contacting surface; and
a second mold removably coupled to the second portion;
a base mold in the base portion, wherein the first mold, second mold, and base mold together define a blow mold cavity when the first portion, the second portion, and the base portion are coupled;
a retainer plate having a longitudinal dimension parallel to the height of the flange, the retainer plate comprising protrusions extending perpendicular to the longitudinal dimension, wherein the protrusions are configured to extend into the space between the positioning dentils such that the protrusions contact the mold contacting surface.

2. The system of claim 1, further comprising a spacer removably coupled to the base portion.

3. The system of claim 2, wherein the spacer is disposed between the base portion and a base ring, wherein the base ring is coupled to the first portion and to the second portion.

4. The system of claim 1, wherein the first mold and the second mold are interchangeable with a third mold and a fourth mold.

5. The system of claim 4, wherein the base mold is interchangeable with a second base mold.

6. The system of claim 5, wherein the blow mold cavity defined by the third mold, the fourth mold, and the second base mold has a maximum width that is different than a maximum width of the blow mold cavity defined by the first mold, the second mold, and the base mold.

7. The system of claim 6, wherein the third mold, the fourth mold, and the second base mold together define a blow mold cavity that has a maximum height that is different than a maximum height of the blow mold cavity defined by the first mold, the second mold, and the base mold.

8. The system of claim 1, wherein the blow mold cavity defined by the first mold, the second mold, and the base mold has a volume from about 100 mL to about 2 L.

9. The system of claim 8, wherein:
the first mold is interchangeable with a third mold;
the second mold is interchangeable with a fourth mold;
the base mold is interchangeable with a second base mold; and
a blow mold cavity defined by the first mold, the second mold, and the base mold has a volume from about 2 L to about 3 L.

10. The system of claim 1, wherein the base mold is integral with the base portion.

11. The system of claim 2, wherein the first mold and the retainer plate are configured to be directly coupled to the first portion.

12. An interchangeable mold for blow molding a container, the mold comprising:
a first mold configured to engage with a first portion of a blow mold carrier, the first mold comprising:
a pair of flanges extending in opposite directions;
positioning dentils extending out from the flanges, wherein the positioning dentils are configured to contact a mold contacting surface of the first portion of the blow mold carrier;
a second mold configured to engage with a second portion of the blow mold carrier;
a base mold configured to engage with the first portion and the second portion of the blow mold carrier to form a blow mold cavity defined by the first mold, the second mold, and the base mold; and
a retainer plate configured to couple the first mold to the first portion of the blow mold carrier.

13. The mold of claim 12, wherein the retainer plate comprises protrusions extending perpendicular to a longitudinal dimension of the retainer plate.

14. The mold of claim 13, wherein the retainer plate is configured to couple to the first mold such that the protrusions extend into the space between the positioning dentils.

15. The mold of claim 13, wherein the protrusions are configured to contact the mold contacting surface.

16. The mold of claim 13, wherein the first mold is configured to be interchangeable with a third mold, the third mold comprising a pair of flanges extending in opposite directions and positioning dentils extending out from the flanges, and
wherein the second mold is configured to be interchangeable with the fourth mold.

17. The mold of claim 16, wherein the retainer plate is configured to couple the third mold to the blow mold carrier.

18. The mold of claim 17, wherein the protrusions extend into the space between the positioning dentils in the third mold.

19. The system of claim 16, wherein the blow mold cavity defined by the first mold, the second mold, and the base mold has a volume from about 100 mL to about 2 L.

20. The system of claim 19, wherein the volume is from about 100 mL to about 1 L.

21. The system of claim 19, wherein the blow mold cavity defined by the third mold, the fourth mold, and the base mold has a volume from about 2 L to about 3 L.
